(19) United States
(12) Patent Application Publication
(10) Pub. No.: US 2026/0366858 A1
(43) Pub. Date: Nov. 19, 2026

(54) LOCATING DEVICE FOR A WORKPIECE

(71) Applicant: Rockroth Oy, Martinkylä (FI)

(72) Inventor: Andreas STENROTH, Martinkylä (FI)

(73) Assignee: Rockroth Oy, Martinkylä (FI)

(21) Appl. No.: 19/515,403

(22) PCT Filed: Aug. 30, 2024
(86) PCT No.: PCT/EP2024/074315

§ 371 Date: Feb. 27, 2026

(30) Foreign Application Priority Data
Aug. 31, 2023 (FI) 20235972

(51) Int. Cl. G01B 11/00; B23Q 17/22

(52) U.S. Cl. CPC G01B 11/002; B23Q 17/22

(57) ABSTRACT

A device (100) for determining a location on a workpiece (130), in that the device (100) comprises: a frame (102) arranged to be movable by a first motor (104) along a longitudinal direction of the workpiece (130), consequently moving the whole device (100) on and/ or over the workpiece (130) along said direction, wherein the first motor (104) is arranged to the frame (102), positioning means (108) to position the frame (102) in relation to at least one side or edge of the workpiece (130) so that the frame (102) may move along the longitudinal direction in relation to the workpiece (130), a measuring point (110) connected to movable means (112), which movable means (112) facilitate movement of the measuring point (110) by a second motor (114) along a transverse and/or vertical direction in relation to the workpiece (130) and with respect to the frame (102), wherein the second motor (114) is arranged to the frame (102) or to the movable means (112), measuring equipment (116a) for determining the location of the measuring point (110) in longitudinal respect to the workpiece (130) and measuring equipment (116b) for determining the location of the measuring point (110) in a transverse and/or vertical direction in relation to the at least one side of the workpiece (130) to which the frame (102) is positioned with the positioning means (108), computing means coupled with the first motor (104) and the second motor (114) and the measuring equipment (116a, 116b), and arranged to receive location information of the measuring point (110) from the measuring equipment (116a, 116b), control the first motor (104) and the second motor (114) to move the measuring point (110) to a location on the workpiece (130)

### FIELD OF THE INVENTION

Generally, the present invention relates to measuring equipment. In particular, however not exclusively the present invention pertains to a device for determining location on a workpiece.

### BACKGROUND

Traditionally when boring holes or measuring points on a workpiece, such as a beam, the user has to manually measure and mark the points on the beam in accordance with schematics. The manual measurements are done in relation to the beam and accuracy is totally dependent on the accuracy of the different measuring devices, such as a roll measure, and the proficiency of the worker using them.

Additionally, the beams may vary in dimensions and the schematics might not correspond to the actual beam dimensions that further decreases the accuracy of the measured points. After the dimensions have been measured usually machining such as drilling, coping or welding takes place at the measured points or lines.

Additionally, CNC (Computerized Numerical Control) machine arrangements are known from the prior art wherein a workpiece is guided and machined through a big apparatus which measures, conveys and machines a workpiece as it travels through the CNC machine. These apparatuses are however big in size, complex in structure, not manually operable (except via a computer user interface) and they cost more than typical manual measuring means.

### SUMMARY OF THE INVENTION

The objective is to at least alleviate the problems described hereinabove not satisfactorily solved by the known arrangements, and to provide a feasible solution for a device for determining location on a workpiece.

The main advantage of the device in accordance with the present invention is that it comprises all the necessary measuring means incorporated in the device itself. This has a benefit of easier use, and the solution can mitigate user error and inaccuracy.

One further advantage of the device in accordance with the present invention is that the arrangement is motorized allowing automatic operation of the device. The device may also be quickly moved from workpiece to another.

A further advantage of the present invention is that it allows for accuracy that is sufficient in regard to relevant workpiece measuring and machining standards for a wide range of measured distances. This is an important advantage when working with e.g. elongated workpieces such as beams and girders that may require both small distance and longer distance measurements wherein the accuracy of those measurements should stay in the tolerances set by relevant standards. The present invention is preferably aimed at elongated workpieces, but its features and the core invention may encompass also other shapes as is clear to a person skilled in the art.

The technical effect of the present invention is that a user can place the device on any longitudinal workpiece, such as an I-beam or an H-beam, position the device in relation to the workpiece so that the dimensions of the workpiece provide direct references for the measurements of the device, and provide input to the device so that the device can do measurement and move in relation to the workpiece.

The aforesaid objectives are achieved by the embodiments of a device in accordance with the present invention.

Accordingly, in one aspect of the present invention a device for determining a location on a workpiece, in that the device comprises:
a frame arranged to be movable by a first motor along a longitudinal direction of the workpiece, consequently moving the whole device on and/or over the workpiece along said direction, wherein the first motor is arranged to the frame,
positioning means to position the frame in relation to at least one side or edge of the workpiece so that the frame may move along the longitudinal direction in relation to the workpiece,
a measuring point connected to movable means, which movable means facilitate movement of the measuring point by a second motor along a transverse and/or vertical direction in relation to the workpiece and with respect to the frame, wherein the second motor is arranged to the frame or to the movable means,
measuring equipment for determining the location of the measuring point in longitudinal respect to the workpiece and measuring equipment for determining the location of the measuring point in a transverse and/or vertical direction in relation to the at least one side of the workpiece to which the frame is positioned with the positioning means,
computing means coupled with the first motor and the second motor and the measuring equipment, and arranged to
   receive location information of the measuring point from the measuring equipment,
   control the first motor and the second motor to move the measuring point to a location on the workpiece.

Further embodiments of the disclosure are presented in the dependent claims.

The utility of the present invention follows from a plurality of factors depending on each particular embodiment.

The expression “a number of” refers herein to any positive integer starting from one (1), e.g. to one, two, or three.

The expression “a plurality of” refers herein to any positive integer starting from two (2), e.g. to two, three, or four.

Different embodiments of the present invention are disclosed in the dependent claims.

### BRIEF DESCRIPTION OF THE RELATED DRAWINGS

Next the invention is described in more detail with reference to the appended drawings in which

FIG. 1 illustrates an isometric view of an embodiment of the device in accordance with the present disclosure,

FIG. 2 illustrates an isometric view of an embodiment of the device with a computing entity in accordance with the present disclosure,

FIG. 3 illustrates a bottom view of an embodiment of the device in accordance with the present disclosure,

FIG. 4 illustrates a side view of an embodiment of the device in accordance with the present disclosure,

FIG. 5 illustrates a top view of an embodiment of the device in accordance with the present disclosure,

FIG. 6 illustrates an isometric view of an embodiment of the device with a swivel arm arranged to the frame in accordance with the present disclosure,

FIG. 7 illustrates an isometric view of an embodiment of the device with a swivel arm coupled with a motor to the frame in accordance with the present disclosure,

FIG. 8 illustrates an isometric view of an embodiment of the device with a swivel arm attached to a workpiece sideways in accordance with the present disclosure,

FIG. 9 illustrates an isometric view of an embodiment of the device where the measuring point measures the inner wall of a workpiece in accordance with the present disclosure,

FIG. 10 illustrates an isometric view of an embodiment of the device where the measuring point measures the outer wall of a workpiece in accordance with the present disclosure.

### DETAILED DESCRIPTION OF THE EMBODIMENTS

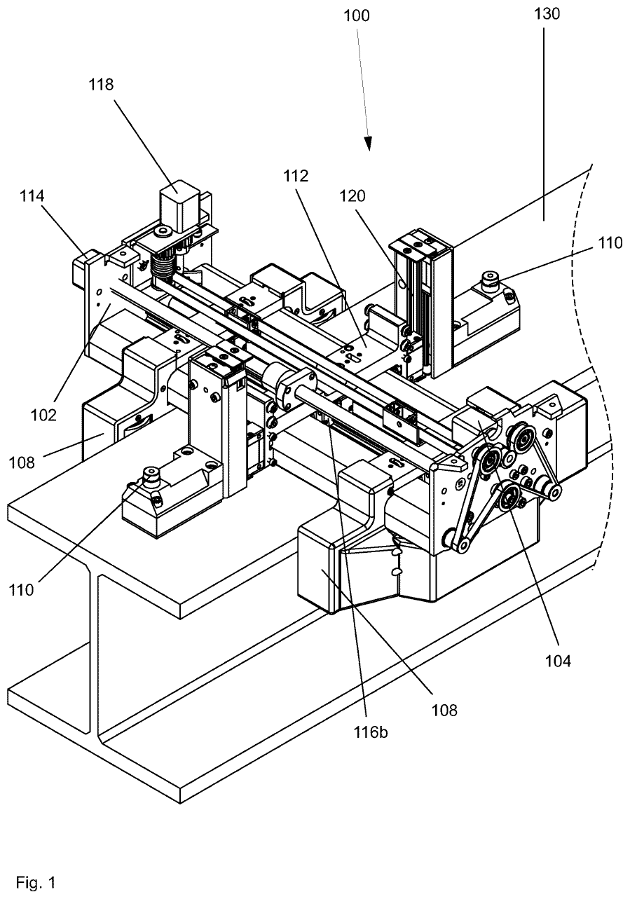

Referring to FIG. 1 the device (100) comprises a frame (102) that is movable by a first motor (104) along a longitudinal direction of the workpiece (130) such as a bar or I-beam or an H-beam which may be elongated in shape, consequently moving the device (100) on and/or over the workpiece (130) along said direction. The frame (102) is held in place along longitudinal direction of the workpiece (130) with positioning means (108) so that the positioning means (108) position the frame (102) in relation to at least one side of the workpiece (130). The positioning means (108) position the frame (102) so that the frame (102) does not move in a transverse direction in relation to the workpiece (130) but may move along the longitudinal direction of the workpiece (130). The positioning means (108) may comprise rolls which position the device (100) to the sides of the workpiece (130) and provide movement in longitudinal direction in relation to the workpiece (130). Alternatively, the frame (102) may comprise rolling members (106) at the bottom and top parts of the frame (102) to provide movement in longitudinal direction in relation to the workpiece (130). The first motor (104) may be coupled with the rolling members (106). The positioning means (108) may comprise mechanical means such as one or more rolls that which may move in relation to the workpiece (130) and/or magnetic means such as one or more magnets which provide force to hold the frame (102) against the workpiece (130). Alternatively, the positioning means (108) may comprise a shape such as around 90-degree angle which allows positioning of the device (100) in relation to a corner, side or edge of the workpiece (130). Therefore, the positioning means (108) may position the device (100) in relation to the workpiece (130) by manually using the device (100) in relation to the workpiece (130) and/or the positioning means (108) may comprise magnetic or mechanic means to fix the device (100) against the workpiece (130).

A measuring point (110) is connected to movable means (112) powered by a second motor (114) where measuring equipment (116a), not shown in FIG. 1, uses the measuring point (110) to determine longitudinal distance along the workpiece (130). The measuring point (110) may have a marker arranged to it which is another method to track travelled distance in relation to the workpiece (130). Therefore, the movable means (112) constitutes a moving support for the measuring point (110) which may optionally also serve as a point of attachment for a tool. Another measuring equipment (116b) uses the measuring point (110) to determine transversal and/or vertical distance in relation to the at least one side of the workpiece (130). The second motor (114) facilitates movement with movable means (112) along a transverse and/or vertical direction in relation to the workpiece (130) with respect to the frame (102). The second motor (114) can be attached to either the frame (102) or movable means (112). In an embodiment of the device (100), wherein the positioning means (108) comprise means to position the frame (102) from two sides of the workpiece (108), a third motor (118) is arranged to move the positioning means (108) to position the frame (102) from two sides of the workpiece (130).

The measuring point (110) constitutes a point whose location is moved by moving the device (100) on the workpiece (130). The location of the measuring point (110) is measured directly or it is used as a reference point in relation to which measurements may be made. The measuring point (110) may comprise a center punch for marking a point in the workpiece (130). The measuring point (110) may also comprise a hole or a placement for machining tool such as a drill bit, for example. The measuring point (110) may comprise a scriber, printer, or such marker for producing a mark of measurement. Such mark may be a point, a number of points, a line or a curvilinear path, which mark may be produced while the device (100) is moving or stationary. Alternatively, the measuring point (110) comprises a hole for a center punch, and a separate center punch or pen may be used to mark a center point through the hole. The measuring point (110) may hence comprise a physical point of the device (100) or a reference point to which a measured point or line may be defined. Alternatively, or additionally, the measuring point (110) may serve as a point of attachment for a tool.

The device (100) further comprises measuring equipment (116a, 116b) for determining the longitudinal and transverse and/or vertical location of the measuring point (110) with respect to the workpiece (130). The measuring equipment (116a) is used to determine the location of the measuring point (110) in longitudinal respect to the workpiece (130) and the measuring equipment (116b) is used to determine the location of the measuring point (110) in a transverse and/or vertical direction in relation to at least one side or edge of the workpiece (130) to which the frame (102) is positioned with the positioning means (108). The longitudinal and transversal and/or vertical distance is preferably measured from at least one end, edge or side of the workpiece (130) in relation to the measuring point (110). The measuring equipment (116a, 116b) may comprise a laser distance meter measuring the distance to a point of reference such as at least one longitudinal and transverse and/or vertical end, edge or side of the workpiece (130). The laser distance meter may be arranged in the frame (102) wherein the laser equipment is situated at the frame (102) such that the measurement may be done unobstructed by the dimensions of the device (100). Further, the laser distance meter is preferably a component that may be connected to the processor of the device (100). Alternatively, the laser distance meter may be a dedicated measurement device that has a processor of its own to measure the longitudinal and transverse and/or vertical distance. Alternatively, or additionally, the measuring equipment (116a) may be facilitated by a measuring roll or disc, or via the optional rolls which may be used in the device (100). Clearly, the measuring equipment may be situated in many different locations of the device (100) and the calculation of the measuring point (110) in relation to the measuring equipment reading may be done internally in the device in view of the device (100) configuration, dimensions, etc. The measuring equipment (116a) and the measuring equipment (116b) may be facilitated by a single component or a number of components arranged together.

In an embodiment, the device (100) may provide means to reduce the weight or stress caused by the device (100) on the workpiece (130). Such means may comprise, for example, extensions from the device (100) to the ground or means to hang the device (100) in relation to the workpiece (130) thereby taking at least some of the load of the device (100) off the workpiece (130).

A counterpart may be arranged to a point of reference so that the laser beam is reflected from the counterpart. For example, a counterpart may be arranged at the end of the workpiece (130) so that the laser distance meter measures the distance to that end of the workpiece (130). Alternatively, the device (100) may comprise at least two laser distance meters that measure the distance to at least two reference points. Therein the two laser distance meters may be located on opposite sides of the frame (102). For example, the two reference points may be located in each end of the workpiece (130) so that the at least two distance meters measures the distance to each end. The counterpart may be such that almost any surface or object induced reflection is suitable and hence no particular reflection surface is required. However, a dedicated counterpart is not mandatory to the functioning of the device (100) although it may be used to improve the accuracy of the measurements done with the device (100). Especially a white-colored surface of the counterpart may be used improve the accuracy of the longitudinal and transverse and/or vertical measurement. However, also a wall of a building, another beam, such as an inter-section of beams or a bend at the beam, or a point at a stand whereon the workpiece (130) is laid may be used for facilitating reflection for the laser device measurements.

The measuring equipment (116a, 116b) for determining the longitudinal and transverse and/or vertical distance and location may comprise mechanical tape measure roll wherein measuring is done at the device (100) but the tape may be drawn to the side or end(s) of the workpiece (130). Such means may also be used to determine the transverse distance from at least one side of the elongated workpiece (130).

The movable means (112) comprise a part that is moved in relation to the transverse direction of the workpiece (130). The movable means (112) may be facilitated by the part moving via a drive screw or a leadscrew that is turned with a knob at the end of the screw on either side of the frame (102) or by hand by pushing the movable means (112) and/or fine adjusting with another knob. The transverse movement measured by the measuring equipment (116b) may comprise preferably an optical sensor such a pulse sensor or distance sensor such as a laser distance sensor. The pulse sensor may be situated at the end of the screw, such as that rotating the knob rotates a plate in between a pulse sensor wherein the rotation may be measured as pulses and the pulses may be further translated into a measure of transverse movement. Optionally, the pulse sensor may be arranged to the movable means (112) such as that the sensor moves linearly with the movable means (112) and measures its own location in reference to a surface of the frame (102) or to the surface of the workpiece (130). Therein the sensor itself is in the moving part and the pulses are situated at a rail, track, leadscrew or a surface as mentioned before in relation to which the movable means (112) move. The transverse movement may be optionally measured with a magnetic sensor arrangement such as a magnetic sensor moving in relation and at least functional connection to a magnetic strip. The magnetic sensor may be arranged to the movable means (112) such as that the sensor moves linearly with the movable means (112) and measures its movement in reference to the magnetic strip on the frame (102) surface. Therein the magnetic sensor itself is in the moving part and the magnetic strip is fixed on the frame (102) surface so that the magnetic sensor travels against the magnetic strip when the movable means (112) are moved.

In another embodiment, the device (100) can be positioned to the workpiece (130) from one side but have positioning means (108) on both sides of the device (100). In an alternative embodiment, the device (100) may also comprise a hook or such element which may be extended to the opposite side of the positioning means (108). This hook or such element may be used to provide the positioning means (108) force and/or pressure to secure the device (100) in relation to the workpiece (130). However, this hook or such element may provide a measurement tool for measuring the width of the workpiece (130) from the positioning means (108).

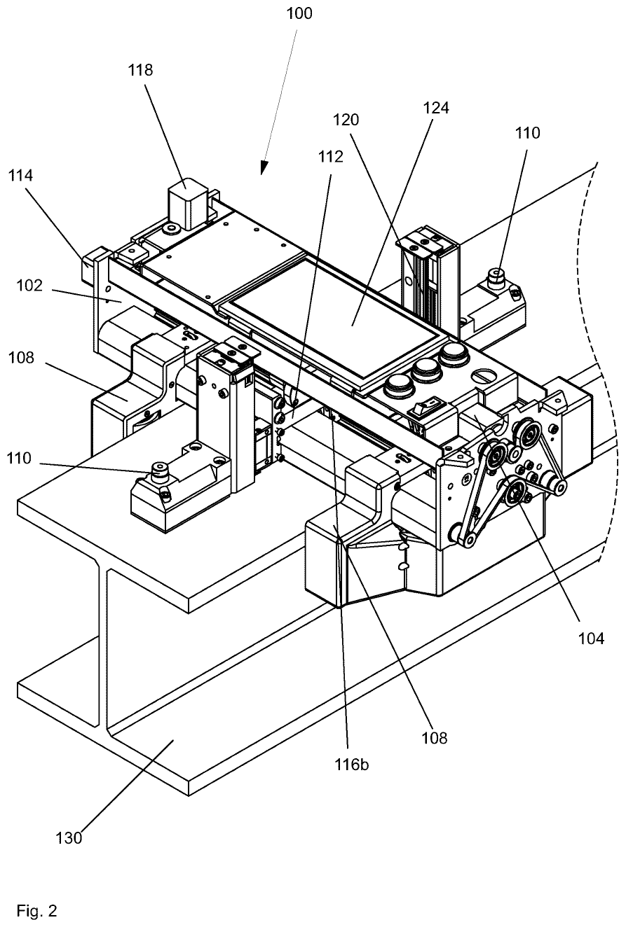

FIG. 2 depicts an upper view of an embodiment of the device (100) and the frame (102). FIG. 2 is similar to FIG. 1 with the exception of an added top layer that houses a screen and buttons for operating the device (100) computationally. In the embodiment, the measuring equipment (116a, 116b) is used to receive location information of the measuring point (110) which is then received by computing means (124) coupled with the first motor (104), the second motor (114) and the measuring equipment (116a, 116b). In the same embodiment, the computing means (124) is used to control the first motor (104) and the second motor (114) to move the measuring point (110) to a desired location on the workpiece (130). The tasks of the computing means (124) may be carried out at the device (100) as illustrated or at least partly or completely remotely. The user input to operate the computing means (124) may be G-code.

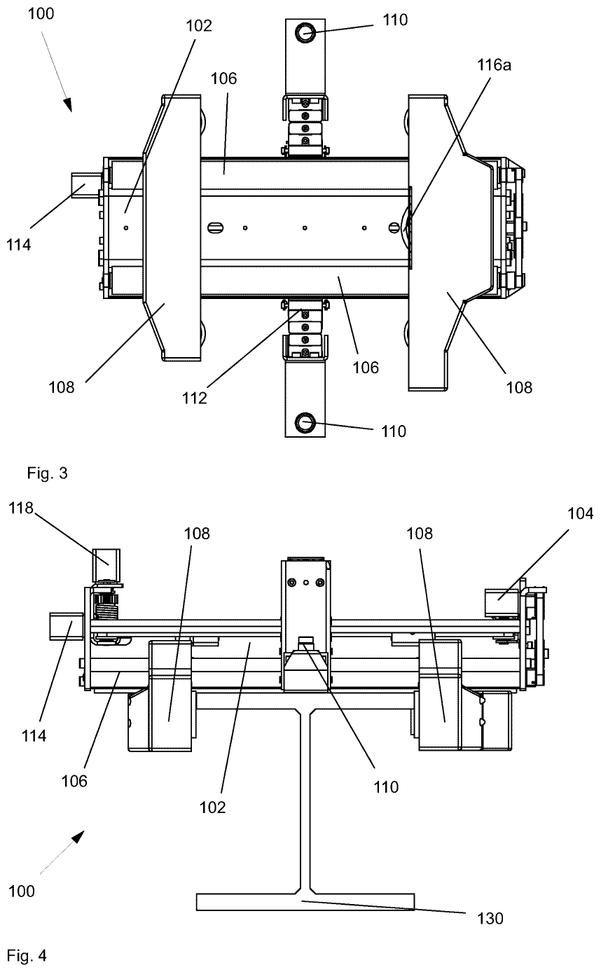

FIG. 3 depicts the device (100) and frame (102) from a bottom view. Rolling members (106) are shown on the bottom and the upper sections of the device (100). The first motor (104), which is not shown in FIG. 3, operates the rolling members (106) to create longitudinal movement of the frame (102) in relation to the workpiece (130). The positioning means (108) are shown on the left and right sides of the device (100) with small wheels to lock the frame (102) against the workpiece allowing controlled longitudinal movement of the device (100) along the workpiece (130) together with the first motor (104) and the rolling members (106). Two measuring points (110) are shown extending from movable means (112) on the bottom and upper sections of the device (100). The second motor (114) is shown on the upper left side of the device (100). Measuring equipment (116a) is shown on the right-side positioning means (108) in the middle of the said positioning means (108).

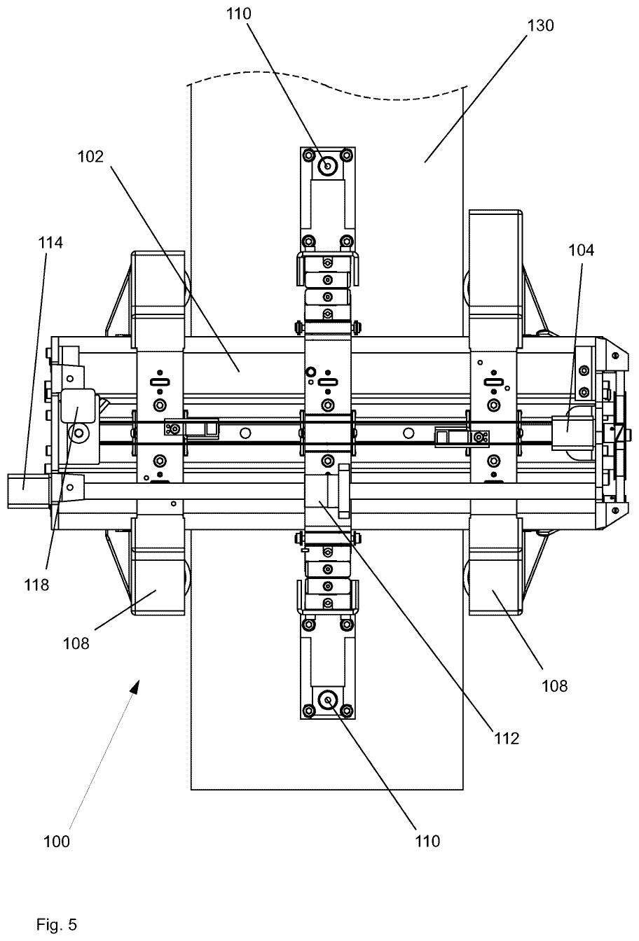

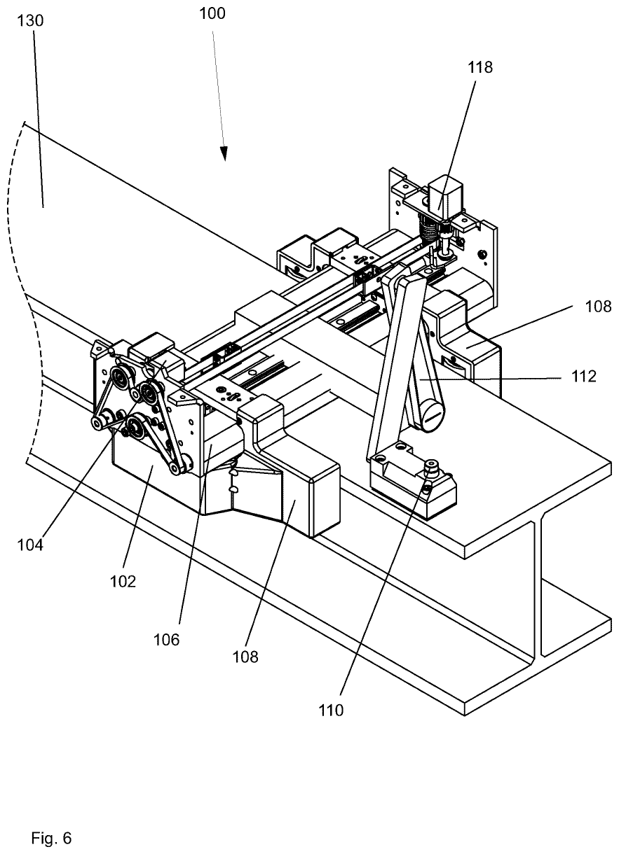

FIG. 4 depicts a side view of the device (100) attached to the workpiece (130). The measuring point (110) can be seen to be in close contact with the workpiece (130). In FIG. 5 it can be seen how the positioning means (108) and the rolls of the positioning means (108) align with the workpiece (130) from a top view. The rolls of the positioning means (108) are in direct contact with the workpiece (130).

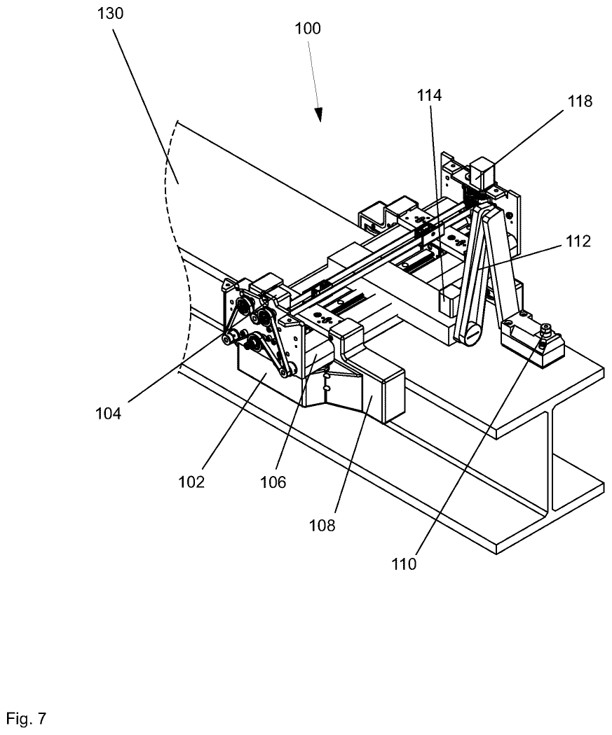

FIGS. 6 and 7 depict another embodiment of the device (100) comprising a swivel arm. In the embodiment, the second motor (114) is arranged to the frame (102) and is coupled with movable means (112) that moves the measuring point (110) like a swivel arm in a transverse and/or vertical direction in relation to the workpiece (130). The second motor (114) is able to determine transversal and/or vertical distance with the measuring point (110) in relation to the at least one side of the workpiece (130). Such a swivel arm may also comprise telescopic parts to extend or decrease the length of the swivel arm.

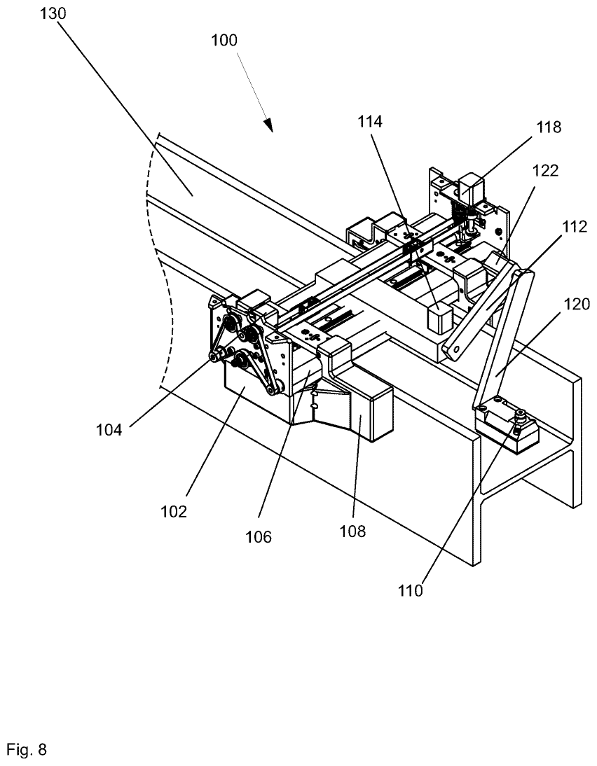

In another embodiment, as depicted by FIGS. 8-10, the swivel arm formed by the movable means (112) and the measuring point (110) has a second movable means (120) placed between the movable means (112) and the measuring point (110). The second movable means (120) is coupled with a fourth motor (122) that moves the second movable means (120) in a third, such as depthwise, direction in relation to the workpiece (130). As such, the swivel arm is able to move the measuring point (110) in a transverse and/or vertical and depthwise direction in relation to the workpiece (130). The fourth motor (122) is able to determine depthwise distance with the measuring point (110) in relation to the workpiece (130).

In FIG. 8, an embodiment of the device (100) is placed so that it measures distance from the connecting middle section of the H-beam workpiece (130). The swivel arm structure comprising the movable means (112), second motor (114), second movable means (120) and the fourth motor (122) make it possible for the device (100) to measure surfaces that are on a lower level in relation to the device (100). As such, regardless of the embodiment, the device (100) can measure distance from the sides, top surface or ends of the workpiece (130).

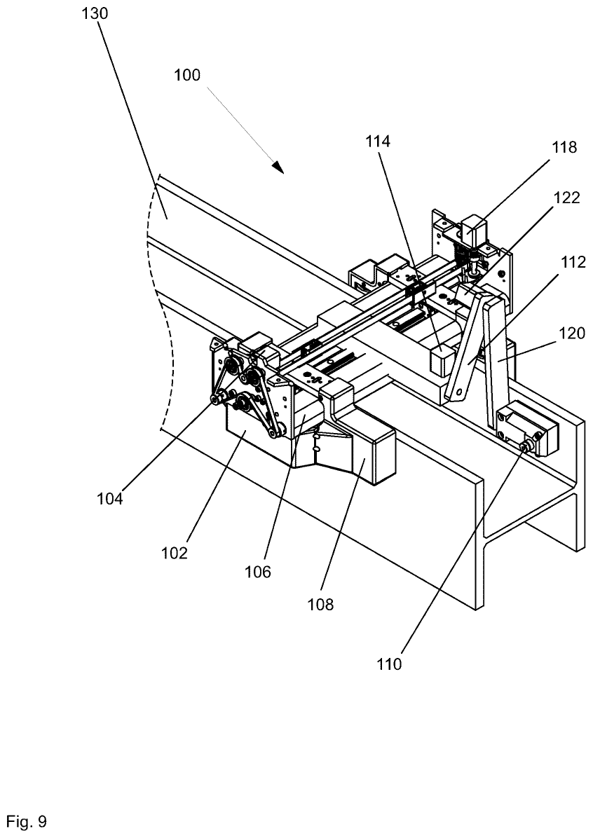

FIG. 9 depicts an embodiment of the device (100) measuring the inner sidewall of the H-beam workpiece (130). The swivel arm and the measuring point (110) are placed so that the device (100) can be used to measure vertical surfaces and/or different horizontal surfaces of the workpiece (130).

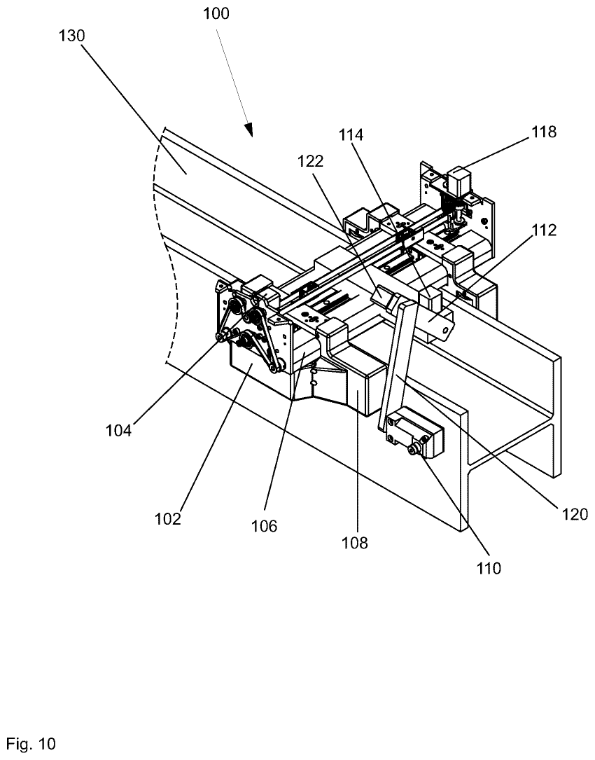

In FIG. 10, the device (100) is placed similarly as in FIGS. 8-9. However, the embodiment shows the multidirectional movement of the swivel arm that allows for the embodiment to measure the outer surface of the H-beam workpiece (130). Additionally, the swivel arm can be arranged so that the measuring point (110) is on a lower level in relation to the device (100).

In an embodiment, the swivel arm may comprise optical means for measuring the longitudinal and transverse and/or vertical distance and location in relation to the workpiece (130).

Regardless of the embodiment, the device (100) measures distance using the measuring point (110) and measuring equipment (116a, 116b) or one or more motors (104, 114, 118, 122) in relation to the workpiece (130). In an embodiment, where there is no measuring equipment (116a, 116b), the servo motors (104, 114, 118, 122) can be used to measure longitudinal, transverse and/or vertical and/or depth-wise distance in relation to the workpiece (130). It is also possible to have a com-bination of measuring equipment (116a, 116b) and one or more motors (104, 114, 118, 122) to measure distance in relation to the workpiece (130).

In an embodiment, measuring of distance may be done by setting a step motor to travel a predefined distance and measuring the distance travelled. Motors such as a BLDC motor (brushless DC motor) and/or moving methods and instruments, such as an FOC (field-oriented control) controller, may also be used to measure distance. The aforementioned step motor is just an example and other motors, con-trollers, instruments and/or tools may also be used.

Furthermore, in an embodiment where the device (100) is equipped with the first motor (104), the second motor (114), the third motor (118) and the fourth motor (122), the motors (104, 114, 118, 122) and the measuring equipment (116a, 116b) are coupled with the computing means (124). The computing means (124) receives location information of the measuring point (110) from the measuring equipment (116a, 116b). The computing means (124) can be used to control the first motor (104), the second motor (114) and the fourth motor (122) to move the measuring point (110) to a location on the workpiece (130). The computing means (124) can also be used to control the third motor (118) to move the positioning means (108) to position the frame from two sides of the workpiece (130).

In an alternative embodiment, the movable means (112) and second movable means (120) can be facilitated by a robotic arm. The aforementioned paragraphs which describe different embodiments of the swivel arm may also be done using the robotic arm. In an embodiment where a robotic arm is used, the longitudinal distance and location may be measured in relation to the surface of the workpiece (130).

The device (100) may be arranged to be compatible and configurable to another device (100).

Consequently, a skilled person may on the basis of this disclosure and general knowledge apply the provided teachings in order to implement the scope of the present invention as defined by the appended claims in each particular use case with necessary modifications, deletions, and additions.

1. A device (100) for determining a location on a workpiece (130), in that the device (100) comprises:
a frame (102) arranged to be movable by a first motor (104) along a longitudinal direction of the workpiece (130), consequently moving the whole device (100) on and/or over the workpiece (130) along said direction, wherein the first motor (104) is arranged to the frame (102),
positioning means (108) to position the frame (102) in relation to at least one side or edge of the workpiece (130) so that the frame (102) may move along the longitudinal direction in relation to the workpiece (130),
a measuring point (110) connected to movable means (112), which movable means (112) facilitate movement of the measuring point (110) by a second motor (114) along a transverse and/or vertical direction in relation to the workpiece (130) and with respect to the frame (102), wherein the second motor (114) is arranged to the frame (102) or to the movable means (112),
measuring equipment (116a) for determining the location of the measuring point (110) in longitudinal respect to the workpiece (130) and measuring equipment (116b) for determining the location of the measuring point (110) in a transverse and/or vertical direction in relation to the at least one side of the workpiece (130) to which the frame (102) is positioned with the positioning means (108),
computing means (124) coupled with the first motor (104) and the second motor (114) and the measuring equipment (116a, 116b), and arranged to:
receive location information of the measuring point (110) from the measuring equipment (116a, 116b),
control the first motor (104) and the second motor (114) to move the measuring point (110) to a location on the workpiece (130).

2. The device (100) of claim 1, wherein the positioning means (108) comprises a number of magnets configured to the side of the workpiece (130).

3. The device (100) of claim 1, wherein the positioning means (108) comprise means to position the frame (102) from two sides of the workpiece (130).

4. The device (100) of claim 1, wherein the first motor (104) is arranged to the frame (102) and a number of rolling members (106) thereat.

5. The device (100) of claim 1, comprising a third motor (118) coupled with the computing means (124) wherein the third motor (118) is arranged to move the positioning means (108) to position the frame (102) from two sides of the workpiece (130).

6. The device (100) of claim 1, comprising second movable means (120) and a fourth motor (122) coupled with the computing means (124) wherein the fourth motor (122) is arranged to move the measuring point (110) in a third direction, such as depth wise, in relation to the workpiece (130).

7. The device (100) of claim 1, wherein the positioning means (108) comprise rolls facilitating longitudinal movement of the frame (102) in relation to the workpiece (130).

8. The device (100) of claim 1, comprising rolling members (106) at the bottom of the frame (102) facilitating longitudinal movement of the frame (102) in relation to the workpiece (130).

9. The device (100) of claim 1, wherein the first motor (104), the second motor (114), the third motor (118) and the fourth motor (122) are servo motors.

10. The device (100) of claim 1, wherein the first motor (104), the second motor (114), the third motor (118) and/or the fourth motor (122) are configured to measure longitudinal, transversal and/or vertical and/or third direction, depthwise, distance.

11. A system or locating and marking a workpiece (130), the system comprising:
a locating device (100) including a frame (102), a first motor (104) arranged to the frame (102), and positioning means (108) configured to align the frame (102) with at least one edge of the workpiece (130);
a movable assembly connected to the frame (102), comprising a measuring point (110) and movable means (112) driven by a second motor (114) to provide movement in a transverse or vertical direction relative to the workpiece (130);
a sensor suite comprising longitudinal measuring equipment (116a) and transverse measuring equipment (116b) configured to detect the position of the measuring point (110) relative to the workpiece (130); and
computing means (124) in communication with the first motor (104), the second motor (114), and the sensor suite, the computing means (124) having a processor configured to:
receive real-time location data of the measuring point (110) from the sensor suite; and
execute control signals for the first and second motors (104, 114) to autonomously translate the measuring point (110) to a target coordinate on the workpiece (130);

12. The system of claim 11, wherein the positioning means (108) comprises a plurality of magnets configured to secure the frame (102) to a side of the workpiece (130).

13. The system of claim 11, wherein the positioning means (108) is configured to engage and position the frame (102) from two opposite sides of the workpiece (130).

14. The system of claim 11, wherein the first motor (104) is coupled to a plurality of rolling members (106) arranged on the frame (102) to facilitate longitudinal movement.

15. The system of claim 11, further comprising a third motor (118) coupled with the computing means (124), wherein the third motor (118) is arranged to actuate the positioning means (108) to lock the frame (102) against two sides of the workpiece (130).

16. The system of claim 11, further comprising a second movable means (120) and a fourth motor (122) coupled with the computing means (124), wherein the fourth motor (122) is configured to move the measuring point (110) in a third direction, such as a depth-wise direction, relative to the workpiece (130).

17. The system of claim 11, wherein the positioning means (108) comprises rolls that facilitate the smooth travel of the frame (102) along the longitudinal axis of the workpiece (130).

18. The system of claim 11, wherein the first motor (104), the second motor (114), the third motor (118), and the fourth motor (122) are servo motors.

19. The system of claim 11, wherein at least one of the first motor (104), the second motor (114), the third motor (118), or the fourth motor (122) is utilized as a sensor to measure distance in their respective directions of movement.

20. A method for determining a location on a workpiece (130) using a motorized locating device (100), the method comprising:
positioning a frame (102) of the locating device (100) against at least one side or edge of the workpiece (130) using positioning means (108) to establish a reference orientation;
translating the locating device (100) along a longitudinal direction of the workpiece (130) via a first motor (104) arranged to the frame (102);
actuating a measuring point (110) via a second motor (114) and movable means (112) along a transverse or vertical direction relative to the frame (102);
determining, via measuring equipment (116a, 116b), the longitudinal and transverse location of the measuring point (110) relative to the workpiece (130);
processing location information at a computing means (124) to calculate the distance between the current location of the measuring point (110) and a desired target location; and
controlling the first motor (104) and the second motor (114) based on the processed information to automatically move the measuring point (110) to the target location on the workpiece (130).
